(19) United States
(12) Patent Application Publication
(10) Pub. No.: US 2005/0212203 A1
(43) Pub. Date: Sep. 29, 2005

(54) Note validating and storage assembly and method

(76) Inventors: Peter Wolfgang DeRaedt, Reno, NV (US); Bernd Witzany, Graz (AT)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/089,868

(22) Filed: Mar. 25, 2005

Related U.S. Application Data
(60) Provisional application No. 60/557,282, filed on Mar. 29, 2004.
(60) Provisional application No. 60/561,361, filed on Apr. 12, 2004.
(60) Provisional application No. 60/592,702, filed on Jul. 30, 2004.
(60) Provisional application No. 60/635,499, filed on Dec. 13, 2004.

(51) Int. Cl. A63F 3/00; G10G 7/02

(52) U.S. Cl. 273/236

(57) ABSTRACT

A note validating and storage assembly for a gaming table having a table top includes a storage box for storing notes received at the gaming table. A validator is disposed adjacent to the storage box for validating the authenticity of the notes and determining the value of the notes. A controller having a memory is in operative communication with the validator for receiving and storing data corresponding to the authenticity and value of the notes. A separator apparatus is disposed adjacent to the validator. The separator apparatus grips one of the notes and separates the one note from a plurality of notes. A holding area is operatively connected to the separator and configured for temporarily holding at least one note in a folded configuration. The holding area is disposed below the table top such that notes may be pushed through a note entry slot in the table top and into the storage area with a plunger. A method of tracking the value of notes received from a player is also disclosed.

### CROSS REFERENCE TO RELATED APPLICATIONS

This application claims priority to U.S. Provisional Application Ser. No. 60/557,282, filed Mar. 29, 2004; U.S. Provisional Application Ser. No. 60/561,361, filed Apr. 12, 2004; U.S. Provisional Application Ser. No. 60/592,702, filed Jul. 30, 2004; and U.S. Provisional Application Ser. No. 60/635,499, filed Dec. 13, 2004, which are hereby incorporated by reference.

### FIELD OF THE INVENTION

The invention relates generally to gaming and more particularly to an assembly and method for receiving, validating, and storing notes at a gaming table.

### BACKGROUND OF THE INVENTION

Casinos have long required that chips be used as the monetary instrument at gaming tables. Dealers must exchange currency from the player for chips to be used at the gaming table. The currency is typically pushed with a plunger down a slot in the gaming table into a secured cash box. The cash boxes at each gaming table are periodically switched out with the full boxes taken to a “count room” where the contents are counted. The exact value of the currency in the cash box is not known until after counting.

With an increasing desire for “real-time” accounting in casinos along with enhanced auditing standards, it is desirous to keep track of the exact value of currency and other notes in the cash box. Various systems and methods for tracking the value of notes in a cash box are known. Two such systems and methods are disclosed in U.S. Pat. No. 5,957,776 to Hoehne (the '776 patent) and U.S. Pat. No. 6,745,887 to Heidel et al. (the '887 patent).

The '776 patent discloses a gaming table tracking system which tracks the value of notes in a cash box. The system includes a table control unit and a plurality of pushbuttons in operative communication with the table control unit. When notes are received from a player, the dealer uses the pushbuttons to enter the position of the player and the value of the notes. The player position and value of the notes is stored in the table control unit. The notes are pushed into the cash box using a plunger. The system of the '776 patent has no ability to authenticate and determine the value of the notes. Furthermore, the system is subject to operator error with mispressed pushbuttons, resulting in a flawed accounting of the exact value of notes stored in the storage box.

The '887 patent discloses a note validator assembly for a gaming table. The assembly includes a bezel for holding a plurality of notes that are laid flat. A separator pulls a single note from the bezel. The single note is pulled into a bill discriminator which determines the authenticity and the value of the note. Valid notes are routed to a cash box while invalid notes are sent to a reject slot. The bezel, separator, and bill discriminator are disposed above a table top of the gaming table. This results in a bulky apparatus occupying valuable space on the table top and is not suitable for dice games, such as craps, and other games where the secure cashbox is installed away from an edge of the table. Furthermore, since the notes are laid flat on the bezel above the table top, it is a difficult variation from the traditional procedure of pushing the notes down a slot in order to get the notes away from the table surface as quickly as possible. This traditional procedure is used at virtually all casino gaming tables.

The present invention is aimed at one or more of the problems identified above.

### SUMMARY OF THE INVENTION

In a first aspect of the present invention, a note validating and storage assembly for a gaming table is provided. The assembly includes a storage box for storing notes received at the gaming table, each note having an associated value. A validator is disposed adjacent to the storage box for validating the authenticity of the notes and determining the value of the notes. A separator apparatus is disposed adjacent to the validator for separating the notes. A holding area is operatively connected to the separator and configured for temporarily holding at least one note in a folded configuration.

In a second aspect of the present invention, a gaming table is provided. The gaming table includes a table top defining a note entry slot. The note entry slot receives at least one note, each note having an associated value. A holding area is disposed below the note entry slot for temporarily holding the at least one note. A separator apparatus is disposed adjacent to the validator for separating the notes. A validator is disposed adjacent to the separator apparatus for receiving the note, validating the authenticity of the note, and determining the value of the note. A storage box is disposed adjacent to the validator for receiving and storing notes.

In a third aspect of the present invention, a method of handling notes received at a gaming table is provided. The method includes the steps of receiving and holding a plurality of notes in a folded configuration and separating a single note from the plurality of notes. The authenticity of the notes is validated and the value of the notes is determined. The value of the notes is recorded and the notes are stored in a storage box.

In a fourth aspect of the present invention, a method for tracking a value of notes received from a player is provided. The method includes the steps of determining the identity of the player and recording the identity of the player. At least one note is received from the player and the value of the at least one note is automatically determined. The value of the note is recorded and associated with the identity of the player.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a note validation and storage assembly showing a storage box and an enclosure disposed below a table top of a gaming table;

FIG. 2 is a block diagram showing the components of the assembly in one embodiment;

FIG. 3 is a block diagram showing the components of the assembly in a more detailed embodiment;

FIG. 4 is a side view of one embodiment of a separator apparatus showing the separation of a single note from a plurality of notes in a holding area;

FIG. 5 is a side view of one embodiment of the separator apparatus showing the retention of the plurality of notes in the holding area while the single note is transferred to a transport mechanism;

FIG. 6 is a top view of a user interface; and

FIG. 7 is a partial cross-sectional side view of a plunger lighting system.

### DETAILED DESCRIPTION OF THE INVENTION

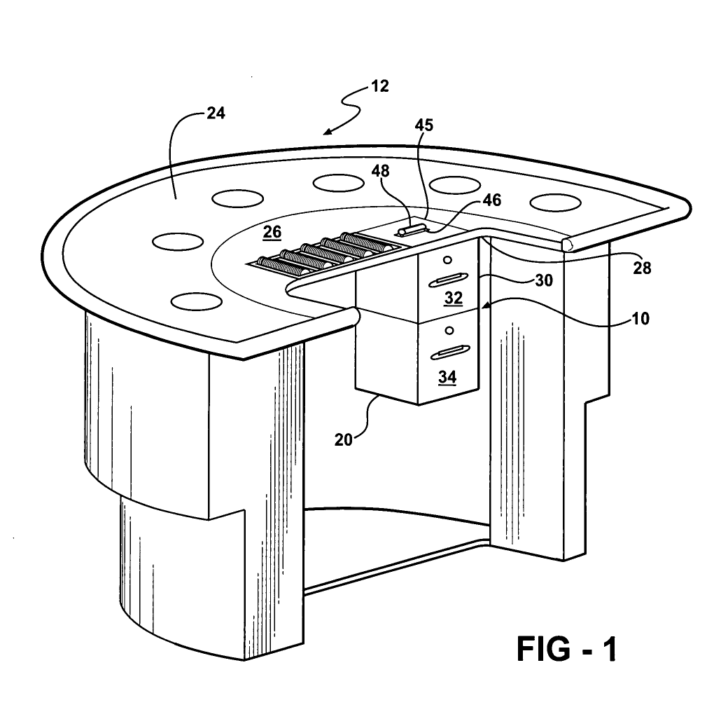

Referring to the Figures, wherein like numerals indicate corresponding parts throughout the several views, a note validating and storage assembly 10 for a gaming table 12 is shown in FIG. 1. The gaming table 12 as shown in FIG. 1 denotes a card game style table as is commonly used in Blackjack, etc. However, the assembly 10 may also be implemented in other style gaming tables 12, including, but not limited to a craps table or a roulette table.

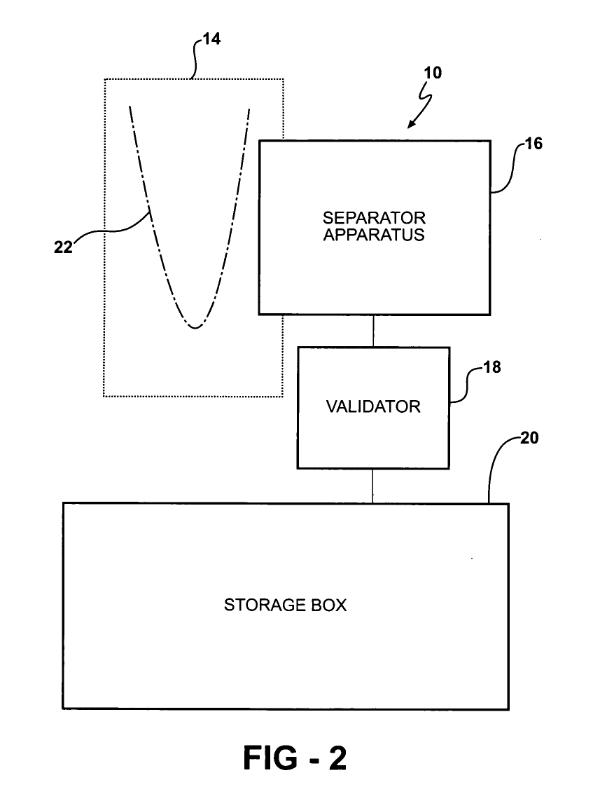

Referring to FIG. 2, in one embodiment, the assembly 10 includes a holding area 14, a separator apparatus 16, a validator 18, and a storage box 20. The holding area 14 temporarily holds at least one note 22 received at the gaming table 12, where each note 22 has an associated value. These notes 22 include, but are not limited to, paper currency, markers, chip fill and credit slips, coupons, gaming machine tickets, or other paper instruments that denote or have an associated value or are used to assist in management related functions. The holding area 14 is configured to hold the at least one note 22 in a folded configuration.

The separator apparatus 16 is disposed adjacent to the holding area 14. The separator apparatus 16 separates the notes 22 temporarily held in the holding area 14. A validator 18 is disposed adjacent to the separator apparatus 16. The validator 18 validates the authenticity of the notes 22 and determines the value or a unique identifier (e.g., in the case of paper instruments other than paper currency) of the notes 22. The storage box 20 is operatively connected to the validator 18. The storage box 20 stores the notes 22 received at the gaming table 12 after the notes 22 pass through the validator 18.

Referring again to FIG. 1, the gaming table 12 includes a table top 24. The table top 24 includes an upper surface 26 where the game is played and a lower surface 28 generally inaccessible by game players. A bracket (not shown) is operatively connected to the lower surface 28. In one embodiment, the assembly 10 includes an enclosure 30 disposed below and supported by the bracket. The holding area 14, separator apparatus 16, and validator 18 are disposed within the enclosure 30. The enclosure 30 includes an enclosure door 32 for accessing the contents of the enclosure 30. The enclosure door 32 includes at least one locking mechanism for securing the enclosure door 32 in a closed position. The enclosure 30 is removably attachable (i.e., separable) from the bracket. This allows for quick replacement of the enclosure 30 in case of a failure of the components therein. The enclosure 30 can also be replaced with a standard cashbox as used in the casino property.

The storage box 20 includes a storage box door 34 for accessing the contents of the storage box 20. The storage box door 34 includes at least one locking mechanism for securing the storage box door 34 in a closed position. In one embodiment, the storage box 20 is disposed below and supported by the enclosure 30. The storage box 20 is removably attachable (i.e., separable) from the enclosure 30 such that the storage box 20 can be transported away from the gaming table 12 (i.e., for removal of the contents) and a replacement storage box 20 substituted in its place.

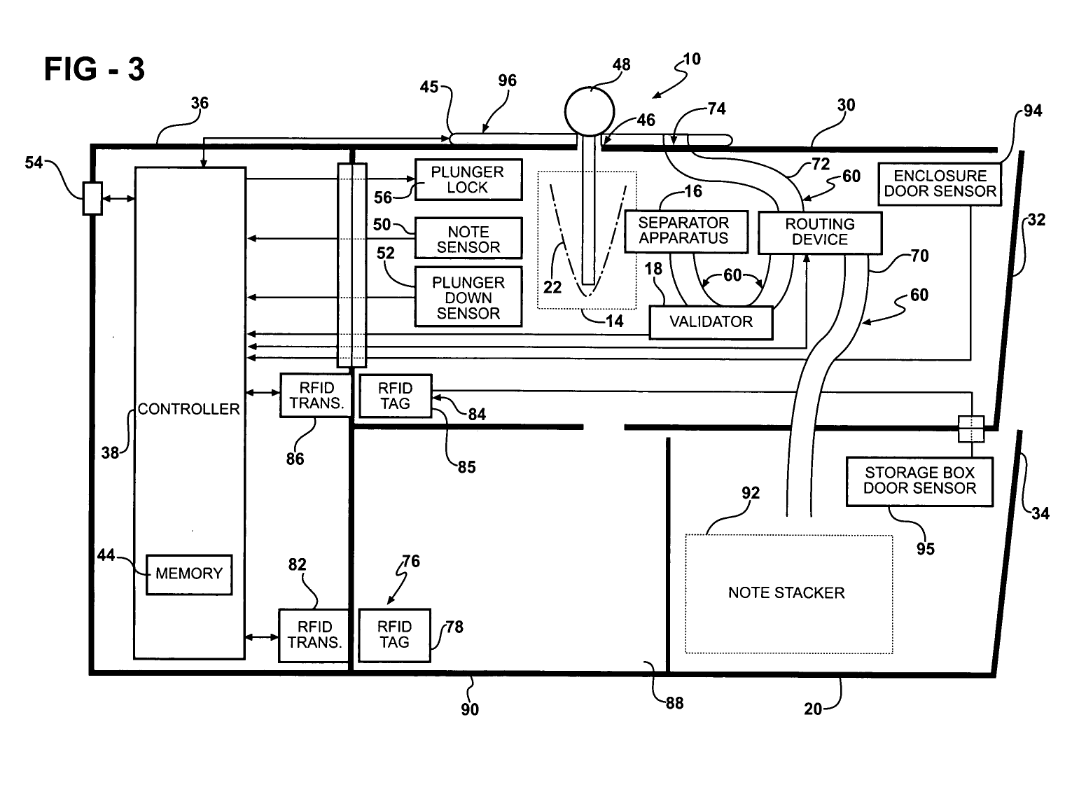

Refer now to FIG. 3, which shows a more detailed embodiment, the assembly 10 includes an electronics compartment 36. The electronics compartment 36 is disposed adjacent to the storage box 20 and the enclosure 30. The electronics compartment 36 is disposed below and supported by the bracket. The electronics compartment 36 is removably attachable (i.e., separable) from the bracket.

A controller 38 is disposed within the electronics compartment 36. The controller 38 may include a microprocessor, a microcontroller, an application specific integrated circuit (ASIC), and/or other suitable device as is well known to those skilled in the art. The controller 38 functions to control various components of the assembly 10 as described in further detail below. Of course, much of the control and interaction between the components may be accomplished without the use of the controller 38. The controller 38 also includes a main memory 44 for storing data. The main memory 44, however, may be separate from but in operative communication with the controller 38.

In one embodiment, a face plate 45 is disposed on the upper surface 26 of the table top 24. The table top 24 and face plate 45 define a note entry slot 46 for receiving at least one note 22. Typically, the dealer will place the note 22 or notes 22 centered atop the note entry slot 46. A plunger 48 may be used to push the note 22 or notes 22 are pushed through the note entry slot 46. By this action, the note 22 or notes 22 become folded generally in half.

The holding area 14 is disposed below the note entry slot 46. The holding area 14 temporarily holds the at least one note 22 pushed through the note entry slot 46 with the plunger 48 in a folded configuration. The enclosure 30 defines a hole disposed between the note entry slot 46 and the holding area 14. The plunger 48, while inserted into the holding area 14, also serves to retain the at least one note 22 in the folded configuration.

A note sensor 50 is disposed within the enclosure 30 and adjacent to the holding area 14. The note sensor 50 is electrically connected to the controller 38 and senses at least one note 22 in the holding area 14. A plunger down sensor 52 is also disposed within the enclosure 30 and adjacent to the holding area 14. The plunger down sensor 52 is electrically connected to the controller 38 to sense that the plunger 48 is fully inserted into the holding area 14. The note sensor 50 and plunger down sensor 52 may be implemented as optical or capacitive type-sensors or any other appropriate sensor as known to those skilled in the art.

A plunger lock 56 is disposed within the enclosure 30 and adjacent to the holding area 14. In one embodiment, the plunger lock 56 is electrically connected to the controller 38 and in operative communication with the note sensor 50 and the plunger down sensor 52. The plunger lock 56 will lock the plunger 48 in place in response to the note sensor 50 sensing at least one note 22 in the holding area 14 and the plunger down sensor 52 sensing that the plunger 48 is fully inserted into the holding area 14. In other embodiments, the plunger lock 56 may be configured to lock the plunger 48 based on other events, which are configurable in the controller 38.

Once the plunger 48 is locked in place, the separator apparatus 16 grips a single note 58 and separates the single note 58 from the other notes 22 being temporarily held in the holding area 14.

The validator 18 is in operative communication with the controller 38. The validator 18 validates the authenticity of the single note 58 and determines the value of the single note 58. Validators of this type are well known to those skilled in the art and typically involve optical scanners including lasers, light emitting diodes (LEDs), and/or optical sensors for validating the single note 58. Data relating to the authenticity of the note 22 and the value of the note 22 is communicated to the controller 38 for storage and analysis. The validator is capable of reading bar codes or other optically-read messages. Accordingly, if the note 22 includes a bar code or other optically-read message, data relating to the bar code or message may also be communicated to the controller 38.

A transport mechanism 60 is operatively connected to the separator apparatus 16 and the validator 18. The transport mechanism 60 moves the note 22 from the separator apparatus 16 and through the validator 18. Transport mechanisms 60 are well known in the art and typically involve a plurality of rollers 62 powered by motors.

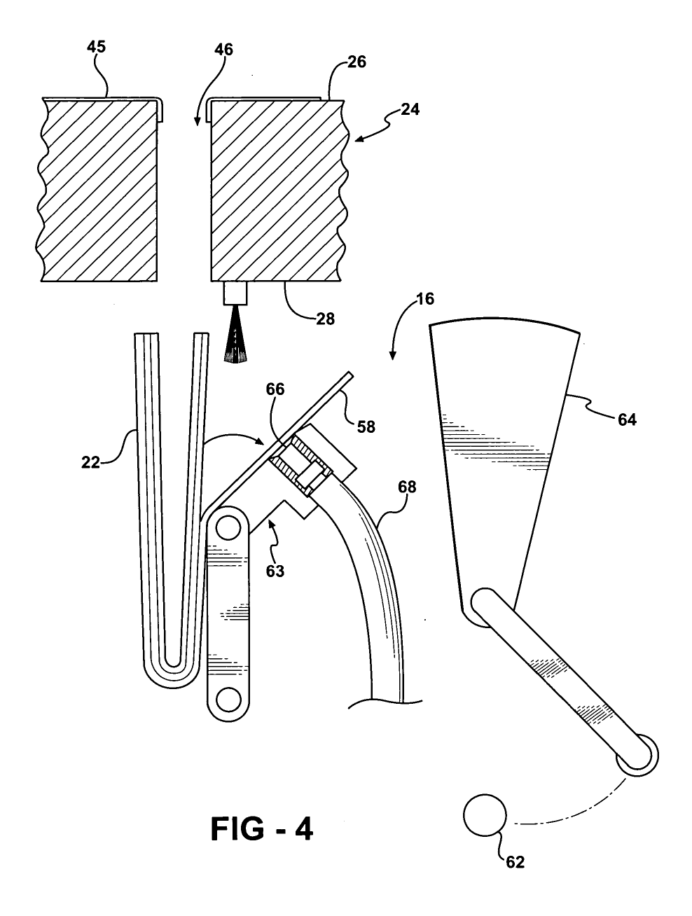

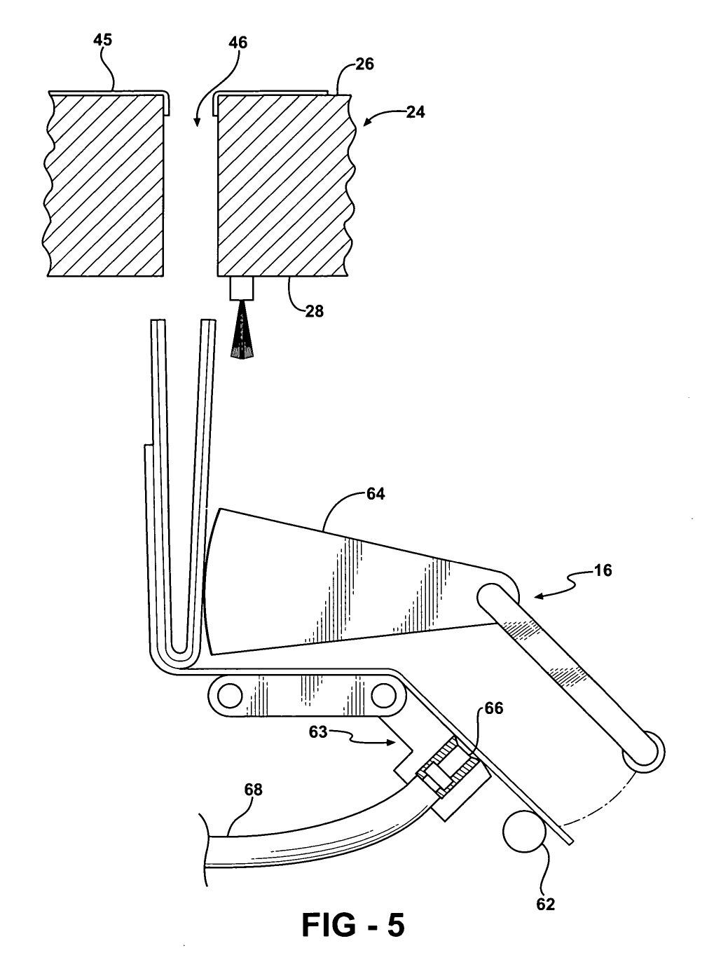

Referring now to FIGS. 4 and 5, in one embodiment, the separator apparatus 16 includes a suction device 63 and a retainer 64. The suction device 63 may include a suction cup 66 and a vacuum line 68 disposed in the center of the suction cup 66 for gripping a note. To separate a single note 58 from the plurality of notes 22 in the holding area 14, the suction device 63 is positioned such that the suction cup 66 is disposed against notes 22. A vacuum is then applied to the vacuum line 68 which pulls a single note 58 toward the suction cup 66. As shown in FIG. 4, the suction device 63 then maneuvers away from the plurality of notes 22; thus separating the single note 58 away from the remaining notes 22. Meanwhile, as shown in FIG. 5, the retainer 64 moves against the remaining notes 22 to retain them in the holding area 14. The single note 58 is placed against one of the rollers 62 of the transport mechanism 60. The transport mechanism 60 then pulls the single note 58 out of the holding area 14 and through the validator 18.

Referring again to FIG. 3, the transport mechanism 60 defines two separate paths for the notes 22 after they pass through the validator 18. A first path 70 routes the notes 22 to the storage box 20 and a second path 72 routes notes 22 to a reject slot 74. The outlet is formed by holes in the table top 24 and the enclosure 30. Typically, notes 22 that are determined authentic by the validator 18 travel along the first path 70 for storage in the storage box 20. Notes 22 that are determined unauthentic travel along the second path 72 to be returned to the dealer via the reject slot 74. However, there may be instances where unauthentic notes 22 travel to the storage box 20.

The transport mechanism 60 includes a routing device 42. The routing device 42 is electrically connected to the controller 38 and in operative communication with the validator 18. The routing device 42 selects between the first path 70 and the second path 72 in response to the authenticity of the note 22 from the validator 18. A solenoid (not shown) may be used to physically change the position of the rollers 62 of the transport mechanism 60 in order to select the appropriate path 70, 72.

The assembly 10 further includes a first transportable memory 76 operatively connected to the storage box 20. The first transportable memory 76 contains a unique identification code for uniquely identifying the storage box 20. The first transportable memory 76 is in operative communication with the controller 38. The value of the notes 22 stored in the storage box 20 is recorded in the first transportable memory 76. The first transportable memory 76 may also record information such as, but not limited to, the total of notes per denomination, the notes provided by identified players, and various management and performance information.

In one embodiment, the first transportable memory 76 may be further defined as a first radio frequency identification (RFID) tag 78, 85 attached to the storage box 20. A first RFID transceiver 82 is attached to the electronics compartment 36 and positioned adjacent the first RFID tag 78. The first RFID transceiver 82 is electrically connected to and in operative communication with the controller 38. The first RFID transceiver 82 reads and writes data to the first RFID tag 78 as directed by the controller 38.

A second transportable memory 84 is operatively connected to the enclosure 30. The second transportable memory 84 contains a unique identification code for uniquely identifying the enclosure 30. The second transportable memory 84 is also in operative communication with the controller 38. Other data, such as the value of the notes 22 passing through the enclosure 30, number of notes 22 validated, etc. may be recorded in the first transportable memory 76.

As with the first transportable memory 76, in one embodiment, the second transportable memory 84 may be further defined as a second RFID tag 85 attached to the enclosure 30. A second RFID transceiver 86 is attached to the electronics compartment 36 and positioned adjacent the second RFID tag 85. The second RFID transceiver 86 is electrically connected to and in operative communication with the controller 38 for reading and writing data to the second RFID tag 85 as directed by the controller 38.

In one embodiment the storage box 20 is divided into a first compartment 88 and a second compartment 90. The first compartment 88 includes at least one note stacker 92 for storing notes 22. An acceptable note stacker 92 is manufactured by JCM American Corporation headquartered in Las Vegas, Nev. Multiple note stackers 92 may be disposed within the first compartment 88 and used to separate paper currency from other types of notes 22 or to separate authentic notes 22 from unauthentic notes 22. The second compartment 90 may be used to store non-paper instruments that denote a value, such as coins or casino chips.

Of course, the storage box 20 may be divided and configured in other ways, depending on particular needs of a casino.

The assembly 10 further includes an enclosure door sensor 94 and an a storage box door sensor 95 for sensing the position of the enclosure door 32 and the storage box door 34, respectively. The door sensors 94, 95 are electrically connected to and in operative communication with the controller 38.

The assembly 10 also includes at least one communication port 54 in operative communication with the controller 38 for exchanging information with a network, a central server, a personal digital assistant (PDA) or other devices as are well known to those skilled in the art. The at least one communication port 54 may include an Ethernet port, a serial port, a radio frequency (RF) port, and/or and infrared (IR) port.

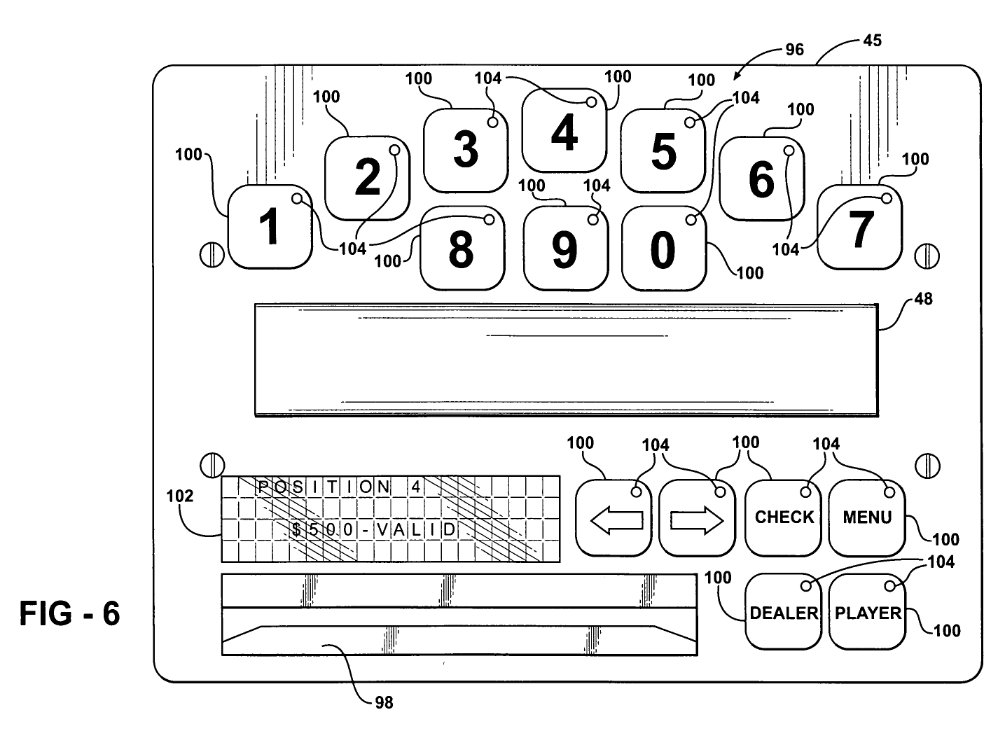

Referring now to FIG. 6, the assembly 10 further includes a user interface 96. The user interface 96 is in operative communication with the controller 38 for allowing a user to communicate with the controller 38. In one embodiment, the user interface 96 is integrated with the face plate 45, which is disposed on the upper surface 26 of the table top 24.

The user interface 96 may includes a card reader 98 for reading an identification card. In one embodiment, the card reader 98 is a magnetic-stripe card reader 98. However, the card reader 98 could also be implemented as a bar code reader, a smart card reader, an RFID reader, or any other type of reading device known to those skilled in the art.

The card reader 98 may also be used to identify the dealer. When taking over or relinquishing operation of the gaming table 12, the dealer swipes his or her identification card to log in or log out. The date, time, and identity of the dealer may then be stored in the memory 44 of the controller 38.

The user interface 96 further includes a plurality of pushbuttons 100 for entering data. The plurality of pushbuttons 100 include ten numeric pushbuttons 100 numbered between 0 and 9. A portion of the numeric pushbuttons 100 are arranged to mirror player positions at the gaming table 12. For example, as shown in FIG. 5, the numeric pushbuttons 100 numbered 1 through 7 are arranged in a semicircular pattern that corresponds to seven player positions at the gaming table 12.

The invention can be utilized to provide a method of tracking a value of notes 22 received from a player. First, the identity of the player is determined. In one embodiment, the player would hand an identification card to the dealer, such as a casino-issued “player's club” type card. The dealer would utilize the card reader 98 to read an identification number and/or other data off the card. The dealer may also record the position of the player by pressing the appropriate pushbutton 100. The identity and playing position of the player is then recorded by the controller 38.

The dealer receives at least one note 22 from the player. The at least one note 22 is pushed into the holding area 14 with the plunger 48. The assembly 10 then automatically determines the value of the at least one note 22. The value of the at least one note 22 is then recorded by the controller 38. The value of the at least one note 22 is associated with the identity of the player. Subsequent notes accepted by the dealer from the player can be associated with the identity of the player without using the identification card, but by the dealer simply pressing the position of the player with the appropriate pushbutton 100.

The user interface 96 also includes a display 102 for displaying information to a user, such as the dealer. This information may include, but is not limited to, instructions to the user, a value of the current or previous note drop, the value of notes for a particular player, and the value of notes in the stored in the storage box. In one embodiment, the display 102 may be a liquid crystal display 102 (LCD) or any other display as is known in the art. The user interface also includes a plurality of indicating lights 104. Each indicating light 104 may be associated with one of the pushbuttons. The indicating lights may be LEDs and are utilized to convey information to the user.

In one embodiment, the user interface 96 may also include a biometric reader (not shown) for determining the identity of the user. The biometric reader is in operative communication with the controller. The biometric reader may sense fingerprint patterns or other unique biometric characteristics.

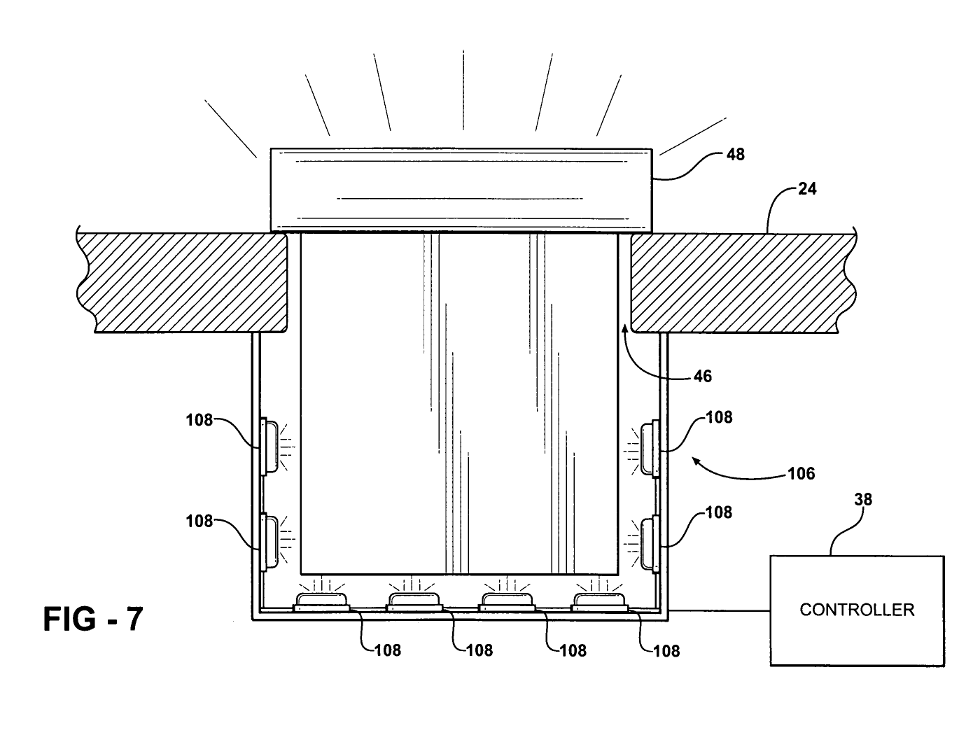

Referring to FIG. 7, in one embodiment, the assembly 10 may also include a plunger lighting system 106 in operative communication with the controller 38 to deliver status information to the user. The plunger 48 is formed of a transparent material, such as a plastic, and includes a handle which is sized larger than the note entry slot 46, such that the handle remains above the table top 24. The plunger lighting system includes at least one light source 108 supported within the enclosure 30 and positioned adjacent to the plunger 48. The positioning of the at least one light source 108 coupled with the transparency of the plunger 48 allows for the handle to illuminate, thus delivering status information. Such status information may include, but is not limited to, normal operation of the system, system failure, the drop box 20 nearing or being at capacity, or the detection of an unauthentic note 22. The light source 108 may be a bicolor LED, an incandescent light, or other lighting source as are known to those skilled in the art.

Obviously, many modifications and variations of the present invention are possible in light of the above teachings. The invention may be practiced otherwise than as specifically described within the scope of the appended claims.

1. A note validating and storage assembly for a gaming table, comprising:
a storage box for storing notes received at the gaming table, each note having an associated value;
a validator disposed adjacent to the storage box for validating the authenticity of the notes and determining the value of the notes,
a separator apparatus disposed adjacent to the validator for separating the notes; and
a holding area operatively connected to the separator and configured for temporarily holding at least one note in a folded configuration.

2. An assembly, as set forth in claim 1, further comprising a transport mechanism operatively connected between the separator apparatus and the validator for moving the note from the separator apparatus and through the validator.

3. An assembly, as set forth in claim 2, wherein the transport mechanism includes a first path operatively connected between the validator and the storage box for moving the note from the validator to the storage box.

4. An assembly, as set forth in claim 3, further comprising a reject slot for returning notes that are determined unauthentic by the validator.

5. An assembly, as set forth in claim 4, wherein the transport mechanism further includes a second path operatively connected between the validator and the reject slot for moving the note from the validator to the reject slot.

6. An assembly, as set forth in claim 5, wherein the transport mechanism further includes a routing mechanism in operative communication with the validator for selecting between the first path and the second path in response to the authenticity of the note.

7. An assembly, as set forth in claim 1, further comprising a plunger for pushing the at least one note into the holding area and retaining the at least one note in the folded configuration.

8. An assembly, as set forth in claim 7, further comprising a note sensor disposed adjacent to the holding area for sensing at least one note in the holding area.

9. An assembly, as set forth in claim 8, further comprising a plunger down sensor disposed adjacent to the holding area for sensing that the plunger is fully inserted into the holding area.

10. An assembly, as set forth in claim 9, further comprising a plunger lock disposed adjacent to the holding area and in operative communication with the note sensor and the plunger down sensor for locking the plunger in place in response to the note sensor sensing at least one note in the holding area and the plunger down sensor sensing that the plunger is fully inserted into the holding area.

11. An assembly, as set forth in claim 1, further comprising a controller in operative communication with the validator for receiving and storing data corresponding to the authenticity and value of the notes.

12. An assembly, as set forth in claim 11, further comprising a first transportable memory operatively connected to the storage box and in operative communication with the controller for recording the value of the notes stored in the storage box.

13. An assembly, as set forth in claim 12, wherein the first transportable memory is further defined as a first radio frequency identification (RFID) tag.

14. An assembly, as set forth in claim 13, further comprising a first RFID transceiver in operative communication with the controller for reading and writing data to the first RFID tag.

15. An assembly, as set forth in claim 11, further comprising a user interface in operative communication with the controller for allowing a user to communicate with the controller.

16. An assembly, as set forth in claim 15, wherein the user interface includes a card reader for reading an identification card.

17. An assembly, as set forth in claim 15, wherein the user interface includes a plurality of pushbuttons for entering data.

18. An assembly, as set forth in claim 17, wherein a portion of the pushbuttons are arranged to mirror player positions at the gaming table.

19. An assembly, as set forth in claim 15, wherein the user interface includes a display for displaying information to the user.

20. An assembly, as set forth in claim 15, wherein the user interface includes at least one indicating light for communicating status of the assembly to the user.

21. An assembly, as set forth in claim 15, wherein the user interface includes a biometric reader in operative communication with the controller for determining an identify of the user.

22. An assembly, as set forth in claim 11, further comprising an enclosure for enclosing the validator, the separator apparatus, and the holding area.

23. An assembly, as set forth in claim 22, wherein the storage box is removably attachable to the enclosure.

24. An assembly, as set forth in claim 22, further comprising a second transportable memory operatively connected to the enclosure and in operative communication with the controller.

25. An assembly, as set forth in claim 22, wherein the enclosure includes an enclosure door for accessing the contests of the enclosure.

26. An assembly, as set forth in claim 25, further comprising an enclosure door sensor in operative communication with the controller for sensing the position of the enclosure door.

27. An assembly, as set forth in claim 11, wherein the storage box includes a storage box door for accessing the contents of the storage box.

28. An assembly, as set forth in claim 27, further comprising a storage box door sensor in operative communication with the controller for sensing the position of the storage box door.

29. An assembly, as set forth in claim 11, further comprising a communications port in operative communications with said controller.

30. A method of tracking a value of notes received from a player comprising the steps of;
determining the identity of the player,
recording the identity of the player,
receiving at least one note from the player,
automatically determining the value of the at least one note,
recording the value of the at least one note, and
associating the value of the at least one note with the identity of the player.

31. A method, as set forth in claim 30, further comprising the step of separating a single note from the at least one note.

32. A method, as set forth in claim 30, wherein the step of determining the identity of the player is further defined as reading an identification card.

33. A method, as set forth in claim 30, wherein the step of determining the identity of the player is further defined as reading biometric characteristics of the player.

34. A method, as set forth in claim 30, wherein the step of automatically determining the value of the at least one note is further defined as reading a bar code disposed on the at least one note.

35. A gaming table comprising;
a table top defining a note entry slot for receiving at least one note,
a holding area disposed below the note entry slot for temporarily holding the at least one note,
a separator apparatus disposed adjacent to the validator for separating the notes;
a validator disposed adjacent to the separator apparatus for receiving the note, validating the authenticity of the note, and determining the value of the note, and
a storage box disposed adjacent to the validator for receiving and storing notes.

36. A gaming table, as set forth in claim 35, wherein said table top defines a reject slot for returning notes that are determined unauthentic by the validator.

37. A gaming table, as set forth in claim 36 further comprising a transport mechanism operatively connecting between the separator apparatus and the validator for moving the note from the separator apparatus and through the validator.

38. A gaming table, as set forth in claim 37, wherein the transport mechanism includes a first path operatively connected between the validator and the storage box for moving the note from the validator to the storage box and a second path operatively connected between the validator and the reject slot for moving the note from the validator to the reject slot.

39. A gaming table, as set forth in claim 35, further comprising a plunger slidably engageable with the note entry slot for pushing the at least one note through the note entry slot and into the holding area and retaining the at least one note in the folded configuration.

40. A gaming table, as set forth in claim 35, further comprising a controller in operative communication with the validator for receiving and storing data corresponding to the authenticity and value of the notes.

41. A gaming table, as set forth in claim 40, further comprising a first transportable memory operatively connected to the storage box and in operative communication with the controller for recording the value of the notes stored in the storage box.

42. A method of handling notes received at a gaming table, wherein each note has an associated value, said method comprising the steps of:
receiving and holding a plurality of notes in a folded configuration;
separating a single note from the plurality of notes;
validating the authenticity of the notes;
determining the value of the notes;
recording the value of the notes; and
storing the notes in a storage box.

43. A method, as set forth in claim 42, wherein the step of separating a single note from the plurality of notes is further defined as the steps of gripping the single note and pulling the single note away from the plurality of notes.

44. A lighting system for a gaming table having a table top comprising:
a plunger for pushing at least one note through a note entry slot defined by the table;
said plunger having a handle portion sized larger than the note entry slot for keeping the handle portion above the table top;
said plunger formed of a transparent material; and
at least one light source positioned adjacent the plunger such that the handle portion of the plunger illuminates as the at least one light source illuminates.

45. A system, as set forth in claim 44, further comprising a controller in operative communication with the light source for controlling the light source to provide information to a user.
